(19) United States
(12) Patent Application Publication
(10) Pub. No.: US 2026/0203758 A1
(43) Pub. Date: Jul. 16, 2026

(54) IDENTIFYING SUSPICIOUS BEHAVIOR FROM STRUCTURED DATA AT SCALE USING LARGE LANGUAGE MODELS (LLMS)

(71) Applicant: Capital One Services, LLC, McLean, VA (US)

(72) Inventors: Kritika MITTAL, Dehradun, UT (US); Kishore KARRA, Livingston, NJ (US); Rama Teja GAMPA, Bangalore (IN); Namratesh SHUKLA, Maharashtra (IN)

(73) Assignee: Capital One Services, LLC, McLean, VA (US)

(21) Appl. No.: 19/020,210

(22) Filed: Jan. 14, 2025

(51) Int. Cl. G06Q 20/40; G06F 40/20

(52) U.S. Cl. CPC G06Q 20/4016; G06F 40/20

(57) ABSTRACT

Aspects disclosed provide system and methods for augmenting a large language model (LLM) for fraud detection. The system and methods incorporate custom tools and processes built around LLMs to enhance the functioning of LLMs and to allow the LLMs to better analyze account data with its context in mind, and to help not only prioritize the accounts for investigation, but also give detailed insights into reasons for the account being suspicious for fraudulent activities.

### TECHNICAL FIELD

Aspects relate to generative artificial intelligence (AI), and specifically to large language models (LLMs).

### BACKGROUND

Artificial intelligence (AI) and machine learning (ML) based systems have become indispensable tools for helping identify patterns that are typically not deducible by a human alone, or by a human with conventional non-AI/ML based computer systems.

One promising use case for AI/ML is in the area of fraud detection, and particularly in anti-money laundering (AML) applications. This is because AI/ML efforts require the detection of many nuanced patterns. Humans are ill equipped to perform this analysis alone, and especially at scale. While tools have been implemented to aid in this analysis, they still require significant amounts of manual review. The use of AI/ML can assist in uncovering this fraudulent behavior because AI/ML tools are well suited for detecting nuanced patterns. Thus, enhanced AI/ML tools and systems are needed to allow for to providing these insights.

### SUMMARY

Aspects disclosed herein provide a system and methods for augmenting LLMs to aid in fraud detection. The architecture provided for the system, and the accompanying methods disclosed, incorporates custom tools and processes built around LLMs to enhance the functioning of LLMs and to allow the LLMs to better analyze account data with its context in mind, and to help not only prioritize the accounts for investigation, but also give detailed insights into reasons for the account being suspicious from an AML point of view. While AML is given as the use case, this is not limiting. A person of ordinary skill in the art (POSA) reading this disclosure will recognize that the architecture disclosed may be applied to many other contexts. These include commercial contexts, such as deducing consumer related preferences or determining a consumer's spending habits, or in areas studying behavioral patterns to determine insights into patterns of both humans and non-humans, such as patterns in habits, routines, etc.

In aspects, the system can implement one or more computing devices to perform the aforementioned functionality. In aspects, the one or more computing devices can achieve the aforementioned functionality by processing structured tabular data, and shaping that data into a form that may be more effectively used by a LLM. The shaping can take the form of generating one or more natural language sentences from structured tabular data representing transactions of an account being investigated for AML. In aspects, the system can then input into the LLM, a first prompt generated to determine a risk level of fraud for the account, where the first prompt comprises the one or more natural language sentences. The system can also input into the LLM a second prompt generated to determine a cause of the risk level, wherein the second prompt also comprises the one or more natural language sentences. In aspects, the system can receive from the LLM, a first output indicating the risk level, and a second output indicating the cause of the risk level. In aspects, the system can then categorize the first output based on the risk level. To further optimize the data, the system can remove determined irrelevant causes of the risk level, dates, and mathematical calculations in the second output. In aspects, the system can standardize the second output into a common format. In aspects, the system can compute, based on the category of the first output and the cause of the risk level, one or more metrics to evaluate performance of the LLM in determining causes for the risk level. In aspects, based on the one or more metrics, the system can aid in revising the first prompt and the second prompt. The aforementioned processes may be repeated for further accounts and metrics may be obtained for the cumulative accounts. More on what metrics are computed will be described below. Further, the metrics may be used to inform the revision of the first prompt and the second prompt.

Certain aspects have other steps or elements in addition to or in place of those mentioned above. The steps or elements will become apparent to a POSA from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a POSA to make and use the aspects.

FIG. 1 is an example system for augmenting a LLM for fraud detection according to aspects.

FIG. 2 shows how one or more natural language sentences are generated from structured tabular data according to aspects.

FIG. 3 shows an example first prompt generated to determine a risk level of fraud according to aspects.

FIG. 4 shows an example second prompt generated to determine a cause of the risk level according to aspects.

FIG. 5 is an example method of operating the system according to aspects.

FIG. 6 is an example architecture of the components that may be used to implement the computing devices of the system according to aspects.

### DETAILED DESCRIPTION

Aspects disclosed herein provide a system and methods for augmenting a LLM for fraud detection. The system and methods provide an enhancement to existing LLMs that are not specifically trained to perform AML fraud detection. The system and methods provide this enhancement by building tools to supplement LLM functionality and enhance the LLM's ability to detect fraud by performing a series of data transformations and data shaping prior to the data being input into the LLM. The system can then take the output of the LLM and perform some optimization steps to better evaluate performance of the LLM in determining causes for various risk levels determined for accounts. The system also implements tools to compute metrics to evaluate the performance of the LLM. The output generated may be used to further refine the first prompt and/or the second prompt. Over time, this iterative approach can allow the LLM to yield more accurate results in identifying fraudulent activity.

The approach of the system is to augment LLMs and improve on existing LLM's ability to perform fraud detection in a cost effective way and one that scales. As is recognized by a POSA, LLMs are costly to train in terms of time and money. By using the approach outlined in this disclosure, LLMs may be further refined for a particular purpose, in this case AML fraud detection, without the need to retrain the LLMs for the particular purpose. Rather, the tools described and built around the LLM can fill the gap in the training for the particular purpose. In this way, the system improves technology, specifically LLMs by improving the ability of LLMs to perform a particular function, in this case fraud detection.

The following aspects are described in sufficient detail to enable those skilled in the art to make and use the disclosure. It is to be understood that other aspects are evident based on the present disclosure, and that system, process, or mechanical changes may be made without departing from the scope of aspects of the present disclosure.

In the following description, numerous specific details are given to provide a thorough understanding of the disclosure. However, it will be apparent that the disclosure may be practiced without these specific details. In order to avoid obscuring an aspect of the present disclosure, some well-known circuits, system configurations, architectures, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the disclosure may be operated in any orientation.

The term “module” or “unit” referred to herein may include software, hardware, or a combination thereof in an aspect of the present disclosure in accordance with the context in which the term is used. For example, the software may be machine code, firmware, embedded code, or application software. Also, for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The modules or units in the following description of the aspects may be coupled to one another as described or as shown. The coupling may be direct or indirect, without or with intervening items between coupled modules or units. The coupling may be by physical contact or by communication between modules or units.

### System Overview and Function

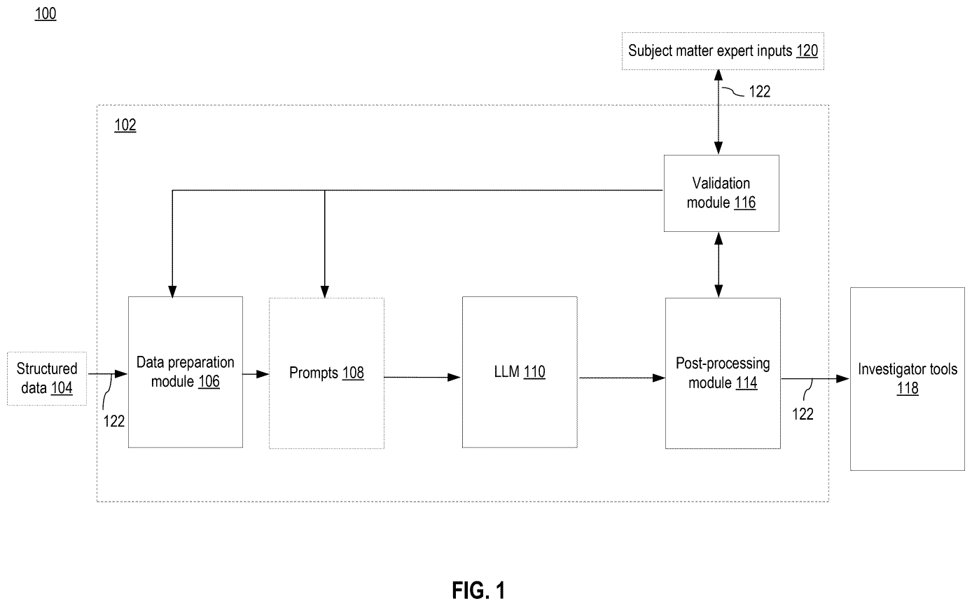

FIG. 1 is an example system 100 for augmenting a LLM for fraud detection according to aspects. In aspects, the system 100 may be implemented on one or more computing devices of backend computing infrastructure, including server infrastructure of a company, for example a financial services company, such as Capital One Services, LLC, of Delaware.

The backend computing infrastructure of the system 100 may be housed in a cloud-computing environment 102. The cloud-computing environment 102 can include server infrastructure. The cloud-computing environment 102 may be a public or private cloud service. A private cloud refers to a cloud environment similar to a public cloud with the exception that it is operated solely for a single organization.

In aspects, the cloud-computing environment 102 can comprise a variety of centralized or decentralized computing devices. For example, the cloud-computing environment 102 may include a mobile device, a laptop computer, a desktop computer, grid-computing resources, a virtualized computing resource, cloud-computing resources, peer-to-peer distributed computing devices, a server, a server farm, or a combination thereof. The cloud-computing environment 102 may be centralized in a single room, distributed across different rooms, distributed across different geographic locations, or embedded within a network 122.

In aspects, and as shown in FIG. 1, the computing devices of the cloud-computing environment 102 may have various software modules stored thereon to enable the functions of the system 100. In aspects, these modules can include a data preparation module 106, a LLM 110, a post-processing module 114, and a validation module 116. Each of these modules will be discussed in detail below.

The network 122 refers to a telecommunications network, such as a wired or wireless network. The network 122 can span and represent a variety of networks and network topologies. For example, the network 122 can include wireless communication, wired communication, optical communication, ultrasonic communication, or a combination thereof. For example, satellite communication, cellular communication, Bluetooth, Near Field Communications (NFC), Infrared Data Association standard (IrDA), wireless fidelity (WiFi), and worldwide interoperability for microwave access (WiMAX) are examples of wireless communication that may be included in the network 122. Cable, Ethernet, digital subscriber line (DSL), fiber optic lines, fiber to the home (FTTH), and plain old telephone service (POTS) are examples of wired communication that may be included in the network 122. Further, the network 122 can traverse a number of topologies and distances. For example, the network 122 can include a direct connection, personal area network (PAN), local area network (LAN), metropolitan area network (MAN), wide area network (WAN), or a combination thereof.

In aspects, and as shown in FIG. 1, the system 100 can perform its functions by first receiving structured data 104 from a data source. The data source may be, for example a computer or database storing the structured data 104. The structured data 104 refers to data that is organized in a standardized format that is easy to access and process. In aspects, the structured data 104 may be in tabular format with rows and columns that define the data attributes. In aspects, the structured data 104 can represent an account, for example a financial account that is being investigated for AML purposes. The data attributes can represent data related to transactions of the account over a period of time. In aspects, data attributes can include, but are not limited to, account numbers, transaction-posting date, transaction date, transaction amount, whether the transaction was a debit or credit, merchant identifiers associated with transactions, merchant names, etc.

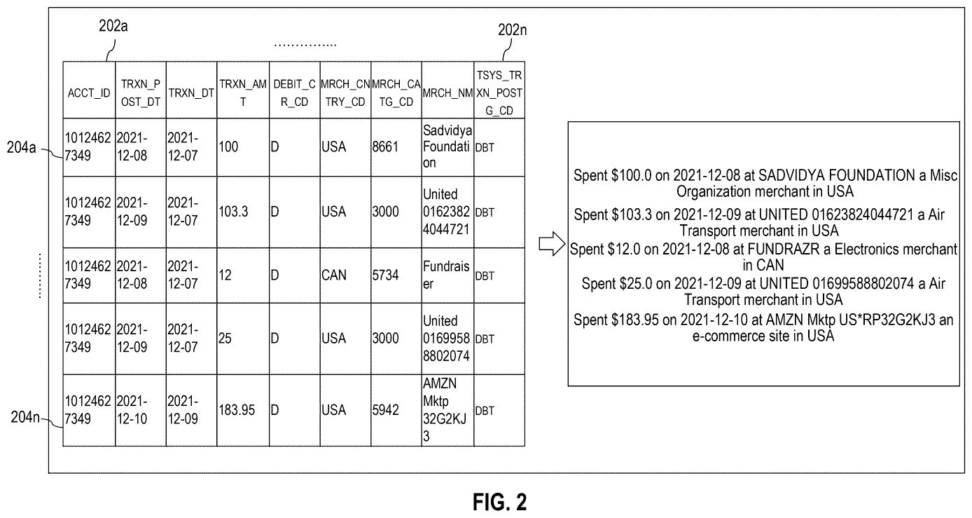

In aspects, the structured data 104 may be received by the data preparation module 106. The data preparation module 106 refers to a software program and/or class of software libraries that when executed by one or more computing devices, performs functions to shape the structured data 104 into a desired format for input into the LLM 110. For example, the data preparation module 106 can generate one or more natural language sentences from the structured data 104. The one or more natural language sentences refer to template sentences specifically engineered to fit a certain format, in which attributes of the structured data 104 may be inserted or used to form the sentences. In aspects, the data preparation module 106 can generate the one or more natural language sentences by using pre-defined templates that are auto-filled with the attributes of the structured data 104. The data preparation module 106 can do this by parsing the structured data 104 and recognizing attributes, and where to insert those attributes. Once recognized, the attributes of a particular row of the structured data 104 may be inserted into the templates based on computer-implemented rules and/or logic. FIG. 2 shows how one or more natural language sentences are generated from structured data 104 according to aspects by the data preparation module 106. In aspects, and as shown in FIG. 2, each of the columns (shown as {202a, . . . 202n}) of the table shown represents an attribute of the account while the rows (shown as {204a, . . . 204n}) show values for those attributes. In aspects, the data preparation module 106 can parse the table for the attribute/value pairs and execute rules or software code to convert these attribute/value pairs into natural language sentences. For example, the data preparation module 106 may be given a template to follow as shown below:
[Transaction type] [Transaction amount] on [Date] at [Merchant] in [Country]

In the template shown above, Transaction type represents the type of transaction such as a debit (spend) or credit (received), Transaction amount represents the amount of the transaction, Date represents the date of the transaction, Merchant represents the name of the merchant which was transacted with, and Country represents the country where the transaction occurred. In aspects, the data preparation module 106 can generate the one or more natural language sentences by parsing the table and forming the one or more natural language sentences by filling in the attribute/values from the table into the template. The right side of FIG. 2 shows example natural language sentences that may be generated. In aspects, the function of the data preparation module 106 may be implemented using software libraries of computer languages such as Python or Perl, or other similar programming languages to perform the parsing, extraction, and sentence generation operations.

In aspects, once the data preparation module 106 generates the one or more natural language sentences, the data preparation module 106 can perform further processing by applying the one or more natural language sentences to stored prompts 108, which can then be input into a LLM (e.g., LLM 110). The prompts 108 refer to custom and structured inputs that when input into the LLM 110, allow the LLM 110 to understand the prompts 108 and allow the LLM 110 to provide meaningful insights based on the prompts 108. In aspects, and in the instant application, the prompts 108 can perform two primary functions. First, the prompts 108 may be engineered to determine a risk level of fraud for the account. Second, the prompts 108 may be engineered to determine a cause of the risk level.

In aspects, subject matter experts can engineer aspects of the prompts 108. Subject matter experts may be individuals such as data scientists, computer scientists, engineers, or system administrators. The subject matter experts can generate aspects of the prompts 108, based on learned insights that can inform ways to get the LLM 110 to generate meaningful insights regarding the risk level or the causes of the risk level based on the one or more natural language sentences. In other aspects, the generation of the prompts 108 may be partially automated based on the subject matter experts engineering aspects of the prompts 108, and then using a prompt programming framework such as the DSPy framework, available through the Stanford NLP library of Stanford University of California, for algorithmically optimizing the prompts 108.

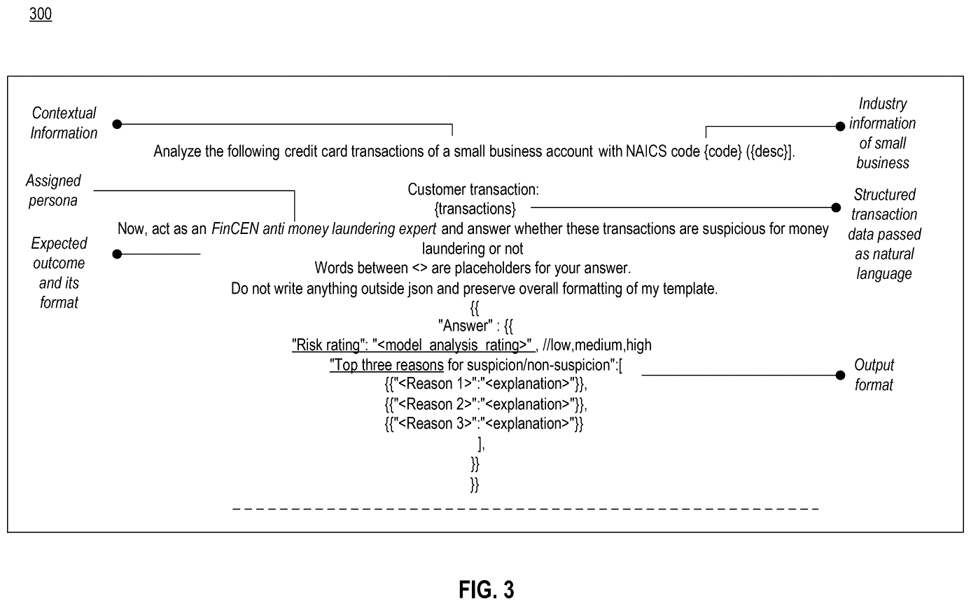

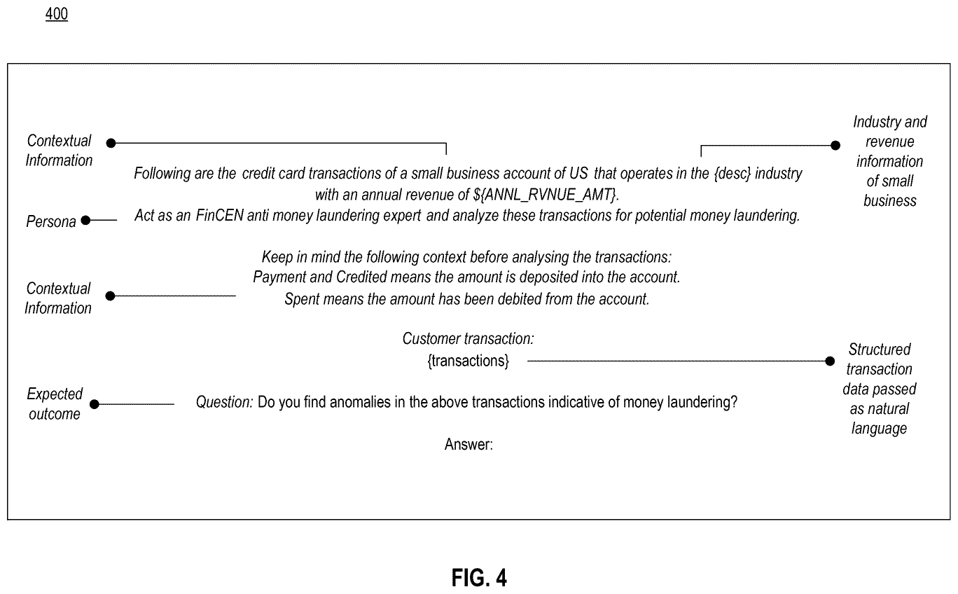

In aspects, the data preparation module 106 can take the aspects of the prompts 108 and modify them to insert the one or more natural language sentences into them and also insert any other data necessary to generate the full prompts 108. FIGS. 3 and 4 show example prompts 108 that may be generated. FIG. 3 shows an example first prompt 300 generated to determine a risk level of fraud according to aspects. In aspects, the first prompt 300 can include several parts.

First, the first prompt 300 can include contextual information. The contextual information refers to a portion of the first prompt 300 that sets the context to provide a clear understanding of the situation being discussed. The contextual information provides background information that informs how to approach the task to the LLM 110. In FIG. 3, it is assumed that the account looked at belongs to a small business, and therefore the contextual information indicates that the LLM 110 is to analyze “credit card transactions of a small business account.” Thus, the contextual information puts a boundary on, and defines the overall task to be performed by the LLM.

Second, the first prompt 300 can include any industry specific information. The industry information can further refine the contextual information so that the context of the task may be confined to a particular subset of data. This further focuses the LLM 110 when it is determining insights. As indicated by FIG. 3, it is assumed that the account looked at is that of a small business and therefore the industry specific information can include a code or identifier that the account is of a small business. In aspects, this industry information may be represented using a code, for example a code that can identify the industry for which the account belongs. Such a code may be a North American Industry Classification System (NAICS) code, which is the standard used by Federal statistical agencies in classifying business establishments for the purpose of collecting, analyzing, and publishing statistical data related to the U.S. business economy.

Third, the first prompt 300 can assign a persona to the LLM 110. The persona refers to a perspective that the LLM 110 is to view the one or more natural language sentences. LLMs may be assigned a persona, i.e., the perspective they need to “behave like” while analyzing data. The persona defines the characteristics, perspective, and the tone that the LLM 110 should adopt when generating a response. In FIG. 3, this persona is shown as that of a “FinCEN anti-money laundering expert.”

Fourth, the first prompt 300 will have the one or more natural language sentences. This was previously discussed above and will not be elaborated on further.

Fifth, the first prompt 300 can indicate what an expected outcome of the LLM 110 should be and its format. The expected outcome tells the LLM 110 what type of outputs are expected and ensures that the LLM 110 generates responses that are accurate, informed, and appropriate to the specific data set provided. In FIG. 3, the expected outcome is given to “answer whether these transactions are suspicious for money laundering or not.” Further expected outcomes give the format in which the outcome is expected by indicating that “Words between < > are placeholders for your answer. Do not write anything outside JSON and preserve overall formatting of [a] template.” FIG. 3 also shows an output format indicating the risk level and the top three causes of the risk level.

FIG. 4 shows an example second prompt 400 generated to determine a cause of the risk level according to aspects. The second prompt 400 is similar to the first prompt 300 except it contains some modifications to the industry information and contextual information as shown in FIG. 4. It also has an additional sixth part, which asks a question seeking to elicit the causes of the risk level. It is important that the way of asking and putting questions is done in a way which is clear, relevant, specific as well as open ended to allow for varied and insightful responses which is free from biases.

Going back to FIG. 1, after the prompts 108 are generated, the data preparation module 106 can pass the prompts 108 to the LLM 110 so that the LLM 110 can run its inferences and generate outputs. The LLM 110 described in this disclosure may be any one of the known LLMs used in industry. For example, the LLM 110 used may be the Large Language Model Meta AI (Llama), of Meta AI, of New York. This, however, is not limiting, and any other commercially or non-commercially available LLM may be used. In aspects, the LLM 110 can run the output through its neural network or transformer networks and based on its training, can generate outputs.

In aspects, and based on the prompts 108, the LLM 110 can generate its output(s). In the present disclosure, since two prompts are given two outputs are generated per account by the LLM 110. One indicating the risk level and the other indicating details on suspected causes of the risk level. In aspects, the output of the LLM 110 may be passed to the post-processing module 114. The post-processing module 114 refers to a software program and/or class of software libraries that when executed by one or more computing devices, performs functions to categorize, remove irrelevant portions of, and standardize the outputs of the LLM 110.

In aspects, the post-processing module 114 can categorize the outputs based on the risk level determined for each account. As indicated by the prompt in FIG. 3, the LLM 110 is to determine a risk level based on three levels, a low risk, a medium risk, or a high risk as required by the output format. In aspects, these risk levels can further translate to the risk level being categorized into three buckets. The low risk level can map an account to a category of flagged account but has no risk of being fraudulent. The medium risk account can map an account to a category that is flagged for review because it may be fraudulent. The high risk account can map an account to a category that is flagged as a high risk of being fraudulent.

In aspects, once categorized, the outputs may be further cleaned to remove irrelevant information. A POSA will recognize that LLMs can produce wrong or irrelevant information. The post-processing module 114 can remove this irrelevant information by implementing computer-implemented rules to recognize patterns in the outputs that are deemed to irrelevant. For example, because the inputs and expected outputs are standardized to meet particular formats as indicated in the prompts 108, irrelevant information will show up similarly and typically in the same patterns across the various outputs for each of the accounts. These patterns may be recognized and rules may be implemented to remove these patterns. For example, the outputs may be refined by removing irrelevant and redundant parts by selecting only the top four reasons given by the LLM 110 as to the causes for the risk level. In addition, pattern recognition techniques are then employed to identify and remove frequently occurring non-useful patterns that lack utility. For example, a non-useful pattern may related to inconsistent payment dates, where several payments were made on weekends, when most businesses are closed, raising questions about the authenticity of the transaction. In this way, data cleaning may be done at scale, improving the LLM 110 output.

In aspects, the post-processing module 114 can also clean the data by removing dates and calculations. As will be recognized by a POSA, the limitations of LLMs in performing calculations and accurately citing dates are addressed by removing these elements from the outputs. This is also achieved through pattern recognition techniques that may be implemented in computer languages such as Python. For example, inconsistent transaction data and amounts can be removed when some transactions show inconsistencies between the date and the amount recorded.

In aspects, a final step in the data cleaning process is to standardize the outputs, particularly those outputs indicating the causes believed to give rise to the level of risk. This standardization can again format the data in a uniform way to present the causes in a common format or to list the causes in a common way across all accounts. In aspects, the standardization can also be informed by the way the outputs will be consumed by downstream components and tools. For example, further software components may be implemented as a part of investigator tools 118 that can use the outputs to generate other outputs. For example, the investigator tools 118 can include report-generating software that can take the outputs and generate reports in natural language formats so that subject matter experts can review the LLM 110 output in a format understandable to a human. As a part of this report generation, charts, statistics, etc. can also be generated based on the outputs. While the scope of the investigator tools 118 is beyond the scope of this disclosure, it is sufficient for a POSA to recognize what type of tools may be included based on a reading of this disclosure.

In aspects, once the post-processing module 114 performs the post-processing and cleanup of the outputs, the outputs may be passed to a validation module 116. The validation module 116 refers to a software program and/or class of software libraries that when executed by one or more computing devices, performs functions to assist in validating the outputs (i.e., assessing the accuracy of the outputs against available benchmarks). This may be done by having the validation module 116 perform computations of one or more metrics based on the outputs. The insights obtained from these computations can help identify whether the LLM 110 is providing useful insights and ultimately helps in improving the input data preparation of the data preparation module 106, the prompt engineering when developing the prompts 108, as well as post-processing of the post-processing module 114 for subsequent iterations of the system 100, when processing further structured data 104. Thus, the validation module 116 helps in improving the overall quality of the LLM 110 output.

In aspects, the validation module 116 can compute one or more metrics. In aspects, these one or more metrics may be computed based on the aggregate outputs of further accounts of multiple accounts. For example, once the system 100 has performed the processing of multiple accounts and saved the outputs for each of these accounts certain metrics may be computed for accounts falling under each of the categories of risk level.

For example, for outputs categorized as flagged account but no risk, metrics may be computed indicating: (1) a first percentage of accounts that fall within the category, (2) a second percentage where causes determined by the LLM 110 for accounts in the category are determined to be useful, and (3) a third percentage where causes determined by the LLM 110 for accounts in the category are determined to not be useful. The computations of (2) and (3) may be aided by subject matter expert inputs 120, which can aid in determining whether causes determined by the LLM 110 are useful or not useful. For example, a subject matter expert can do a check of the causes output by the LLM 110 and tag causes they believe to be useful or not useful for the category, and feed that input back into the validation module 116 to compute the metrics based on the tagging. In aspects, the validation module 116 can further implement AI/ML techniques of patterns in the tags and outputs that can automate the process in the future. Thus, the subject matter expert inputs 120 may be akin to a supervised learning technique that can over time aid in the validation module 116 determine what causes are useful or not useful and determine the percentages associated with each of these.

In aspects, for outputs categorized as flagged account for review, similar metrics may be computed indicating: (1) a fourth percentage of accounts that fall within the category, (2) a fifth percentage where causes determined by the LLM 110 for accounts in the category are determined to be useful, and (3) a sixth percentage where causes determined by the LLM 110 for accounts in the category are determined to not be useful. The techniques described with respect to the flagged but no risk category equally apply for this category of flagged account for review.

In aspects, for accounts categorized as high risk, the validation module 116 can compute a different set of metrics. These can include: (1) a seventh percentage of causes found for accounts in the category by subject matter experts that are also found to be causes determined by the LLM 110, (2) an eighth percentage where causes determined by the LLM 110 for accounts in the category are determined to be useful, and (3) a ninth percentage where causes determined by the LLM 110 for accounts in the category are determined to not be useful. Again, these metrics are aided by subject matter expert inputs 120 that can tag which of these causes are useful or not useful and can form a benchmark to compare the causes found by both the LLM 110 and subject matter experts to be the same. In this way, insights may be obtained as to whether the LLM 110 is aligned with the findings of the subject matter experts. If there is a high percentage of similarity between the two, then the LLM 110 output may be validated as reliable output.

In aspects, for the percentages computed with respect to non-useful causes, the validation module 116 can further categorize these to determine whether they were a result of the LLM 110 hallucinating or not hallucinating. A POSA will understand what is meant by hallucinations are with respect to LLMs. Again, this may be aided by feedback given from subject matter expert inputs 120 that can make this finding on which the categorization may be performed. Over time these findings can also allow the validation module 116 to learn the patterns associated with hallucinations and to have the validation module 116 be able to identify the hallucinations through computer implemented rules and/or AI/ML techniques. This may be further aided by having the validation module 116 connect with separate knowledge sources (e.g., a retrieval augmented generation (RAG) system) that can tap historical data for the accounts to cross-verify whether the output provided by the LLM 110 for the accounts makes sense and is consistent with the historic trends and attributes for the accounts.

The functions of the system 100 may be performed by the modules or units of the backend computing devices of the system 100, for example the computing devices of the cloud-computing environment 102. The modules or units may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the system 100, or installed as a removable portion of the system 100.

It has been discovered that the system 100 described above can help improve LLMs achieve a significant quality in the output when identifying accounts for AML purposes. The system 100 augments existing LLMs by providing a framework and a feedback mechanism that may be used to identify potentially fraudulent activity and continuously refine those findings through a combination of AI/ML techniques, metrics, subject matter expert feedback, and prompt engineering that may be aided by the aforementioned techniques, metrics, and feedback. The system 100 may better help investigators prioritize accounts to review and details of reasons of suspicion will give them an anchor to the investigation, not only reducing overall investigation time but also ensuring a more comprehensive assessment when performing AML investigations.

The system 100 also improves LLMs because it builds tools around existing LLMs that can help supplement LLMs where the LLMs are not specifically trained on a certain task. In this case, the system 100 implements modules and techniques that can aid in filling the gap in LLM training when it comes to identifying accounts and reasons for AML investigations. The feedback looped and continuous refinement based on the outputs can lead to better insights and more accurate assessment of risk levels and causes for those risk levels.

It has been discovered that the initial results of implementing the system 100 yields that for approximately 90% of accounts that are flagged, the system 100 can provide investigators with at least one relevant reason for a categorized risk level. Moreover, for accounts that are categorized as flagged but no risk, the system 100 yields for approximately 93% of these accounts at least one relevant reason for the categorization. For accounts that are categorized as either flagged for review or high risk, 90% of the accounts have at least 50% of the causes captured to be relevant.

### Methods of Operation

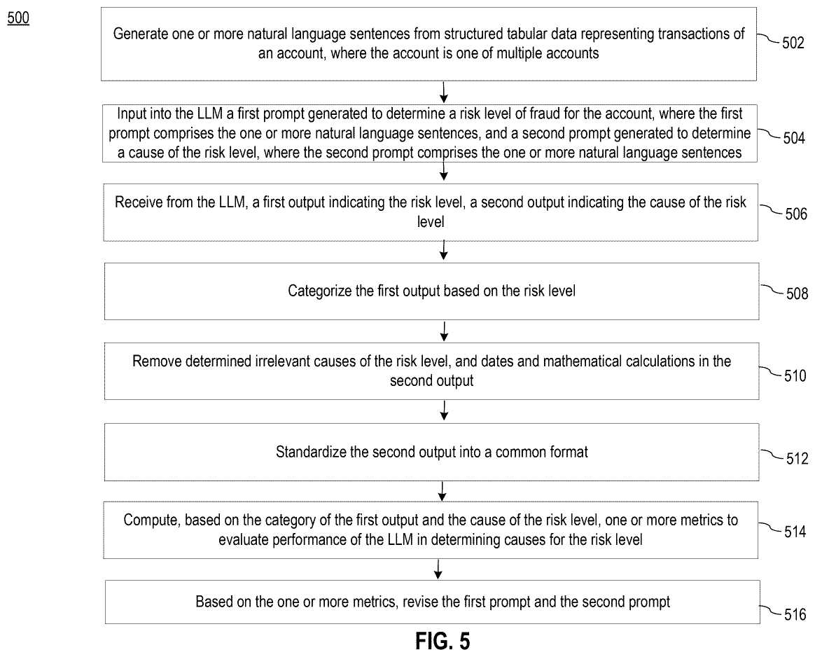

FIG. 5 is an example method 500 of operating the system 100 according to aspects. Method 500 may be implemented on computing devices, for example the computing devices of the cloud-computing environment 102.

In aspects, method 500 may begin by generating one or more natural language sentences from structured tabular data (e.g., structured data 104) representing transactions of an account, where the account is one of multiple accounts, as shown in step 502. In aspects, prompts 108 may be generated and input into an LLM (e.g., LLM 110) including the one or more natural language sentences. For example, a first prompt may be generated and input into the LLM 110 to determine a risk level of fraud for the account, where the first prompt comprises the one or more natural language sentences and a second prompt may be generated and input into the LLM 110 to determine a cause of the risk level, wherein the second prompt also comprises the one or more natural language sentences, as shown in step 504. In aspects, the LLM 110 can generate an output. The output may be received by components of the system 100 (e.g., the post-processing module 114, as shown in step 506. The outputs can include a first output indicating the risk level, and a second output indicating the cause of the risk level. In aspects, the post-processing module 114 can perform several data cleaning functions on the outputs. For example, the post-processing module 114 can categorize the first output based on the risk level, as shown in step 508. The post-processing module 114 can remove determined irrelevant causes of the risk level and dates and mathematical calculations in the second output, as shown in step 510. In aspects, the post-processing module 114 can also standardize the second output into a common format, as shown in step 512. The standardization may be helpful both in validating the output and can help format the output in a way that it may be understood by downstream tools (e.g., the investigator tools 118) when performing tasks such as report generation based on the outputs. In aspects, the system 100 can compute, using the validation module 116 and based on the category of the first output and the cause of the risk level, one or more metrics to evaluate performance of the LLM 110 in determining causes for the risk level, as shown in step 514. Based on the one or more metrics, the first prompt and the second prompt may be revised, as shown in step 516.

The operation of method 500 is performed, for example, by system 100, in accordance with aspects described above. The functions described may be performed according to and consistent with FIGS. 1-4, and by the data preparation module 106, the LLM 110, the post-processing module 114, and the validation module 116 or their equivalents as described above. Such modules may be combined in various ways or manners to perform the functions described with respect to method 500.

### Components of the System

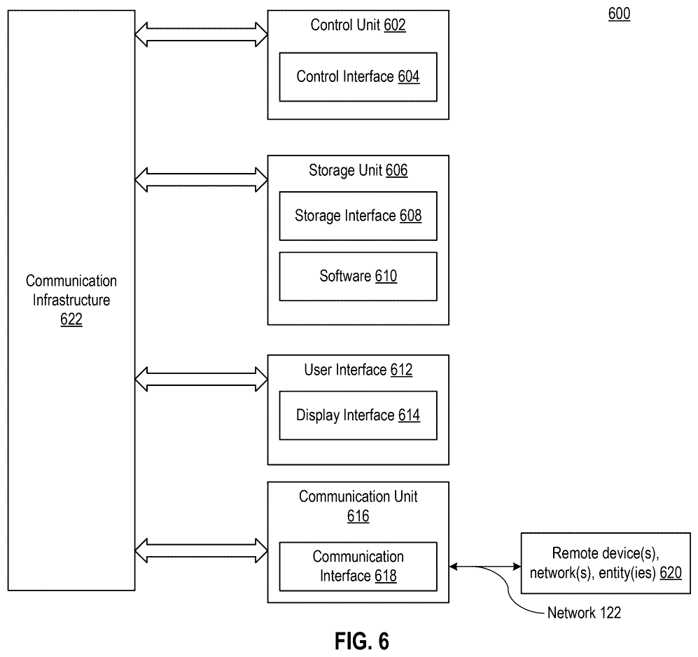

FIG. 6 is an example architecture 600 of the components that may be used to implement the computing devices of the system 100 according to aspects. The components may be implemented on any of the devices of the system 100, for example the computing devices of the cloud-computing environment 102. In aspects, the components may include a control unit 602, a storage unit 606, a communication unit 616, and a user interface 612. The control unit 602 may include a control interface 604. The control unit 602 may execute software 610 to provide some or all of the intelligence of system 100. The control unit 602 may be implemented in a number of different ways. For example, the control unit 602 may be a processor (e.g., central processing unit (CPU) or a graphics processing unit (GPU)), an application specific integrated circuit (ASIC), an embedded processor, a microprocessor, a hardware control logic, a hardware finite state machine (FSM), a digital signal processor (DSP), a field programmable gate array (FPGA), or a combination thereof.

The control interface 604 may be used for communication between the control unit 602 and other functional units or devices of system 100. The control interface 604 may also be used for communication that is external to the functional units or devices of system 100. The control interface 604 may receive information from the functional units or devices of system 100, or from remote devices 620, or may transmit information to the functional units or devices of system 100, or to remote devices 620. The remote devices 620 refer to devices external to system 100, such as any interfaces or computers used by subject matter experts to interact with the system 100 and provide the subject matter expert inputs 120, or the computers of the investigator tools 118, or from computers that the structured data 104 is received.

The control interface 604 may be implemented in different ways and may include different implementations depending on which functional units or devices of system 100 or remote devices 620 are being interfaced with the control unit 602. For example, the control interface 604 may be implemented with integrated circuits, optical circuitry, waveguides, wireless circuitry, wireline circuitry to attach to a bus, an application programming interface (API), or a combination thereof. The control interface 604 may be connected to a communication infrastructure 622, such as a bus, to interface with the functional units or devices of system 100 or remote devices 620.

The storage unit 606 may store the software 610. For illustrative purposes, the storage unit 606 is shown as a single element, although it is understood that the storage unit 606 may be a distribution of storage elements. Also for illustrative purposes, the storage unit 606 is shown as a single hierarchy storage system, although it is understood that the storage unit 606 may be in a different configuration. For example, the storage unit 606 may be formed with different storage technologies forming a memory hierarchical system including different levels of caching, main memory, rotating media, or off-line storage. The storage unit 606 may be a volatile memory, a nonvolatile memory, an internal memory, an external memory, or a combination thereof. For example, the storage unit 606 may be a nonvolatile storage such as nonvolatile random access memory (NVRAM), Flash memory, disk storage, or a volatile storage such as static random access memory (SRAM) or dynamic random access memory (DRAM).

The storage unit 606 may include a storage interface 608. The storage interface 608 may be used for communication between the storage unit 606 and other functional units or devices of system 100. The storage interface 608 may also be used for communication that is external to system 100. The storage interface 608 may receive information from the other functional units or devices of system 100 or from remote devices 620, or may transmit information to the other functional units or devices of system 100 or to remote devices 620. The storage interface 608 may include different implementations depending on which functional units or devices of system 100 or remote devices 620 are being interfaced with the storage unit 606. The storage interface 608 may be implemented with technologies and techniques similar to the implementation of the control interface 604.

The communication unit 616 may enable communication to devices, components, modules, or units of system 100 or to remote devices 620. For example, the communication unit 616 may permit the system 100 to communicate between the modules of the cloud-computing environment 102. The communication unit 616 may further permit the devices of system 100 to communicate with remote devices 620 such as an attachment, a peripheral device, or a combination thereof, through the network 122.

As previously indicated, the network 122 may span and represent a variety of networks and network topologies. For example, the network 122 may include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 122. Cable, Ethernet, digital subscriber line (DSL), fiber optic lines, fiber to the home (FTTH), and plain old telephone service (POTS) are examples of wired communication that may be included in the network 122. Further, the network 122 may traverse a number of network topologies and distances. For example, the network 122 may include direct connection, personal area network (PAN), local area network (LAN), metropolitan area network (MAN), wide area network (WAN), or a combination thereof.

The communication unit 616 may also function as a communication hub allowing system 100 to function as part of the network 122 and not be limited to be an end point or terminal unit to the network 122. The communication unit 616 may include active and passive components, such as microelectronics, communications circuitry, Radio Frequency (RF) circuitry, or an antenna, for interaction with the network 122.

The communication unit 616 may include a communication interface 618. The communication interface 618 may be used for communication between the communication unit 616 and other functional units or devices of system 100 or to remote devices 620. The communication interface 618 may receive information from the other functional units or devices of system 100, or from remote devices 620, or may transmit information to the other functional units or devices of the system 100 or to remote devices 620. The communication interface 618 may include different implementations depending on which functional units or devices are being interfaced with the communication unit 616. The communication interface 618 may be implemented with technologies and techniques similar to the implementation of the control interface 604.

The user interface 612 may present information generated by system 100. In aspects, the user interface 612 allows a user to interface with the devices of system 100 or remote devices 620. The user interface 612 may include an input device and an output device. Examples of the input device of the user interface 612 may include a keypad, buttons, switches, touchpads, soft-keys, a keyboard, a mouse, or any combination thereof to provide data and communication inputs. Examples of the output device may include a display interface 614. The control unit 602 may operate the user interface 612 to present information generated by system 100. The control unit 602 may also execute the software 610 to present information generated by system 100, or to control other functional units of system 100. The display interface 614 may be any graphical user interface such as a display, a projector, a video screen, or any combination thereof.

The above detailed description and aspects of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as a POSA will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting methods and system 100 are cost-effective, highly versatile, and accurate, and may be implemented by adapting components for ready, efficient, and economical manufacturing, application, and utilization. Another important aspect of the present disclosure is that it valuably supports and services the historical trend of reducing costs, simplifying systems, and/or increasing performance.

These and other valuable aspects of the aspects of the present disclosure consequently further the state of the technology to at least the next level. While the disclosed aspects have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the scope of the disclosure should be determined not by the aspects illustrated, but by the appended claims and their equivalents.

What is claimed is:

1. A computer-implemented method for augmenting a large language model (LLM) for fraud detection, the method comprising:
(a) generating, by one or more computing devices, one or more natural language sentences from structured tabular data representing transactions of an account, where the account is one of multiple accounts;
(b) inputting into the LLM,
a first prompt generated to determine a risk level of fraud for the account, wherein the first prompt comprises the one or more natural language sentences, and
a second prompt generated to determine a cause of the risk level, wherein the second prompt also comprises the one or more natural language sentences;
(c) receiving from the LLM,
a first output indicating the risk level,
a second output indicating the cause of the risk level;
(d) categorizing the first output based on the risk level;
(e) removing,
determined irrelevant causes of the risk level, and
dates and mathematical calculations in the second output;
(f) standardizing the second output into a common format;
(g) computing, based on the category of the first output and the cause of the risk level, one or more metrics to evaluate performance of the LLM in determining causes for the risk level; and
(h) based on the one or more metrics, revising the first prompt and the second prompt to further train the LLM for fraud detection for subsequent iterations of the method.

2. The method of claim 1, wherein the risk level is one of:
flagged but no risk;
flagged for review; or
high risk.

3. The method of claim 2, further comprising repeating (a)-(h) for further accounts of the multiple accounts.

4. The method of claim 3, wherein for outputs categorized as flagged but no risk, computing the one or more metrics to include:
a first percentage of accounts that fall within the category of flagged but no risk;
a second percentage where causes determined by the LLM for accounts in the category flagged but no risk are determined to be useful;
a third percentage where causes determined by the LLM for accounts in the category flagged but no risk are determined to not be useful.

5. The method of claim 3, wherein for outputs categorized as flagged for review, computing the one or more metrics to include:
a fourth percentage of accounts that fall within the category of flagged for review;
a fifth percentage where causes determined by the LLM for accounts in the category flagged for review are determined to be useful;
a sixth percentage where causes determined by the LLM for accounts in the category flagged for review are determined to not be useful.

6. The method of claim 3, wherein for outputs categorized as high risk, computing the one or more metrics to include:
a seventh percentage of causes found for accounts in the category of high risk by subject matter experts that are also found to be causes by the LLM;
an eighth percentage where causes determined by the LLM for accounts in the category high risk are determined to be useful;
a ninth percentage where causes determined by the LLM for accounts in the category high risk are determined to not be useful.

7. The method of claim 3, further comprising:
determining whether each of the causes of the risk level is useful or not useful; and
for any causes determined to be not useful, determining what percentage of the not useful causes are hallucinations versus non-hallucinations.

8. A non-transitory computer readable medium including instructions for augmenting a large language model (LLM) for fraud detection that when executed by one or more processors of a computing system, causes the computing system to perform operations comprising:
(a) generating one or more natural language sentences from structured tabular data representing transactions of an account, where the account is one of multiple accounts;
(b) inputting into the LLM,
a first prompt generated to determine a risk level of fraud for the account, wherein the first prompt comprises the one or more natural language sentences, and
a second prompt generated to determine a cause of the risk level, wherein the second prompt also comprises the one or more natural language sentences;
(c) receiving from the LLM,
a first output indicating the risk level,
a second output indicating the cause of the risk level;
(d) categorizing the first output based on the risk level;
(e) removing,
determined irrelevant causes of the risk level, and
dates and mathematical calculations in the second output;
(f) standardizing the second output into a common format;
(g) computing, based on the category of the first output and the cause of the risk level, one or more metrics to evaluate performance of the LLM in determining causes for the risk level; and
(h) based on the one or more metrics, revising the first prompt and the second prompt to further train the LLM for fraud detection for subsequent iterations of the operations.

9. The non-transitory computer readable medium of claim 8, wherein the risk level is one of:
flagged but no risk;
flagged for review; or
high risk.

10. The non-transitory computer readable medium of claim 9, wherein the operations further comprise repeating (a)-(h) for further accounts of the multiple accounts.

11. The non-transitory computer readable medium of 10, wherein for outputs categorized as flagged but no risk, computing the one or more metrics to include:
a first percentage of accounts that fall within the category of flagged but no risk;
a second percentage where causes determined by the LLM for accounts in the category flagged but no risk are determined to be useful;
a third percentage where causes determined by the LLM for accounts in the category flagged but no risk are determined to not be useful.

12. The non-transitory computer readable medium of claim 10, wherein for outputs categorized as flagged for review, computing the one or more metrics to include:
a fourth percentage of accounts that fall within the category of flagged for review;
a fifth percentage where causes determined by the LLM for accounts in the category flagged for review are determined to be useful;
a sixth percentage where causes determined by the LLM for accounts in the category flagged for review are determined to not be useful.

13. The non-transitory computer readable medium of claim 10, wherein for outputs categorized as high risk, computing the one or more metrics to include:
a seventh percentage of causes found for accounts in the category of high risk by subject matter experts that are also found to be causes by the LLM;
an eighth percentage where causes determined by the LLM for accounts in the category high risk are determined to be useful;
a ninth percentage where causes determined by the LLM for accounts in the category high risk are determined to not be useful.

14. The non-transitory computer readable medium of claim 10, wherein the operations further comprise:
determining whether each of the causes of the risk level is useful or not useful; and
for any causes determined to be not useful, determining what percentage of the not useful causes are hallucinations versus non-hallucinations.

15. A computing system for augmenting a large language model (LLM) for fraud detection comprising:
a memory configured to store instructions;
one or more processors, coupled to the memory and configured to process the stored instructions to:
(a) generate one or more natural language sentences from structured tabular data representing transactions of an account, where the account is one of multiple accounts;
(b) input into the LLM,
a first prompt generated to determine a risk level of fraud for the account, wherein the first prompt comprises the one or more natural language sentences, and
a second prompt generated to determine a cause of the risk level, wherein the second prompt also comprises the one or more natural language sentences;
(c) receive from the LLM,
a first output indicating the risk level,
a second output indicating the cause of the risk level;
(d) categorize the first output based on the risk level;
(e) remove,
determined irrelevant causes of the risk level, and
dates and mathematical calculations in the second output;
(f) standardize the second output into a common format;
(g) compute, based on the category of the first output and the cause of the risk level, one or more metrics to evaluate performance of the LLM in determining causes for the risk level; and
(h) based on the one or more metrics, revise the first prompt and the second prompt to further train the LLM for fraud detection for subsequent iterations of the computing system.

16. The computing system of claim 15, wherein the risk level is one of:
flagged but no risk;
flagged for review; or
high risk.

17. The computing system of claim 16, further comprising repeating (a)-(h) for further accounts of the multiple accounts.

18. The computing system of claim 17, wherein for outputs categorized as flagged but no risk, computing the one or more metrics to include:
a first percentage of accounts that fall within the category of flagged but no risk;
a second percentage where causes determined by the LLM for accounts in the category flagged but no risk are determined to be useful;
a third percentage where causes determined by the LLM for accounts in the category flagged but no risk are determined to not be useful.

19. The computing system of claim 17, wherein for outputs categorized as flagged for review, computing the one or more metrics to include:
a fourth percentage of accounts that fall within the category of flagged for review;
a fifth percentage where causes determined by the LLM for accounts in the category flagged for review are determined to be useful;
a sixth percentage where causes determined by the LLM for accounts in the category flagged for review are determined to not be useful.

20. The computing system of claim 17, wherein for outputs categorized as high risk, computing the one or more metrics to include:
a seventh percentage of causes found for accounts in the category of high risk by subject matter experts that are also found to be causes by the LLM;
an eighth percentage where causes determined by the LLM for accounts in the category high risk are determined to be useful;
a ninth percentage where causes determined by the LLM for accounts in the category high risk are determined to not be useful.
